(19) United States
(12) Patent Application Publication
(10) Pub. No.: US 2008/0316203 A1
(43) Pub. Date: Dec. 25, 2008

(54) INFORMATION PROCESSING METHOD AND APPARATUS FOR SPECIFYING POINT IN THREE-DIMENSIONAL SPACE

(75) Inventors: Christian Sandor, Kamakura-shi (JP); Naoki Nishimura, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/125,773

(22) Filed: May 22, 2008

(30) Foreign Application Priority Data
May 25, 2007 (JP) 2007-139373

(51) Int. Cl. G06T 17/00

(52) U.S. Cl. 345/419; 345/632; 382/106

(57) ABSTRACT

An information processing method includes measuring a line-of-sight direction of a user as a first direction, specifying a first point based on the first direction, calculating a three-dimensional position of the first point, setting a first plane based on the three-dimensional position of the first position, measuring a line-of-sight direction of the user after the setting of the first plane as a second direction, specifying a second point included in the first plane based on the second direction, and calculating a three-dimensional position of the second point.

### BACKGROUND OF THE INVENTION

1. Field of the Invention

The present invention relates to an information processing method and apparatus configured to specify a specific point in a three-dimensional space.

2. Description of the Related Art

In recent years, imaging technologies, sensor technologies, and image processing technologies have developed. Now, three-dimensional information such as objects and persons can be virtually displayed. Further, a virtual environment can be superimposed on a real environment and the superimposed image can be three-dimensionally displayed. Further, objects that are captured from different angles are combined and a virtual viewpoint image can be displayed.

The three-dimensional display is presented within user's eyesight not only with vertical and horizontal information about the objects and persons, but also with depth information such as near/far, and front side/back side. Accordingly, a function for observing an objective scene by changing a view point to another view point is important.

For example, in a real environment, there are needs to see a three-dimensional environment from a view point different from a current view point. For example, there is a desire to see scenery viewed from an upper floor before actually constructing a building. Similarly, in a three-dimensional virtual environment, for example, in operation simulation, there can be a demand to see a part that is shaded by an object and cannot be viewed from a current view point by changing the view point to another view point.

In such situations, it is important how to determine a new view point different from a current view point in a three-dimensional space. Japanese Patent Application Laid-Open No. 11-120384 and Japanese Patent Application Laid-Open No. 6-103360 discuss techniques to specify a point or a plane in a three-dimensional space.

Japanese Patent Application Laid-Open No. 11-120384 discusses an input apparatus that can simply and effectively input an operation instruction about an object to be operated in a three-dimensional space from an operation screen displayed in a two-dimensional space. In the input apparatus, a three-dimensional position and a direction of a view point are specified and set by using a flat cursor that is used on a plane surface. The flat cursor can change its shape corresponding to a direction. For example, if the flat cursor is full faced, the shape of the cursor is a square, and if the flat cursor is slanted, the shape is a rectangle. Accordingly, the direction of the view point can be recognized by the cursor shape. The position and direction of the flat cursor is input using a joystick or the like. To specify the position and direction, for example, first, the flat cursor is moved, and then, the direction is set.

In Japanese Patent Application Laid-Open No. 6-103360, an arrow-shaped three-dimensional pointer is used to specify a position and a direction of a view point. In this case, in order to facilitate recognition of setting points, another three-dimensional pointer is further displayed at a midpoint of a line connecting the three-dimensional pointer and an object.

However, in the technique discussed in Japanese Patent Application Laid-Open No. 11-120384, the position of the flat cursor and further its direction need to be specified using the joystick. Furthermore, confirmation of the process is all performed on the two-dimensional space. Accordingly, the specifying operation tends to be complicated. Moreover, it is difficult to recognize where the specified view point is located on the two-dimensional plane that is viewed from above, and the horizontal position needs to be specified at the same time as a position in the height direction is specified. Accordingly, the operation tends to be complicated.

Further, in the technique discussed in Japanese Patent Application Laid-Open No. 6-103360, a complicated operation is required when specifying the position and direction of the three-dimensional pointer. Further, it is difficult to recognize where the specified view point is located on the two-dimensional plane that is viewed from above.

Furthermore, in these technologies, the cursor and the three-dimensional pointer are moved using a user interface such as the joystick. Accordingly, if these technologies are applied to portable apparatuses, the operation is especially troublesome and a large load is imposed on a user.

### SUMMARY OF THE INVENTION

The present invention is directed to readily specifying a viewpoint position in a three-dimensional space.

Further, the present invention is directed to increasing distance perspective, facilitating confirmation in specifying a position, and reducing troublesome operation when a user inputs an instruction about the position of a view point in a three-dimensional space.

Further, the present invention is directed to specifying objects that actually or virtually exist and can be viewed from a current view point while clearly recognizing the objects and their positional relationship, and to readily specifying a specific point in a three-dimensional space so that the operations can also be easily implemented on a small screen of a portable apparatus, or the like.

According to an aspect of the present invention, an information processing method includes measuring a line-of-sight direction of a user as a first direction, specifying a first point based on the first direction, calculating a three-dimensional position of the first point, setting a first plane based on the three-dimensional position of the first point, measuring a line-of-sight direction of the user after the setting of the first plane as a second direction, specifying a second point included in the first plane based on the second direction, and calculating a three-dimensional position of the second point.

According to another aspect of the present invention, an information processing method includes displaying a real space captured by an imaging apparatus on a display apparatus, specifying a direction from a view point toward an object as a first line-of-sight direction using the displayed image, specifying an intersection of the first line-of-sight direction and a three-dimensional model in a scene stored in a storage unit as a first point, calculating a three-dimensional position of the first point based on the three-dimensional model, setting a first plane based on the three-dimensional position of the first point, displaying the real space captured by the imaging apparatus on the display apparatus, specifying a direction from a view point toward the object as a second line-of-sight direction using the displayed image, specifying an intersection of the second line-of-sight direction and the first plane as a second point, and calculating a three-dimensional position of the second point.

According to another aspect of the present invention, an information processing method includes displaying a real space captured by an imaging apparatus on a display apparatus, specifying a direction from a view point toward an object as a first line-of-sight direction using the displayed image, measuring a depth in the first line-of-sight direction, specifying a first point using the first line-of-sight direction and the depth, calculating a three-dimensional position of the first point based on a position of the imaging apparatus, the first line-of-sight direction, and the depth, setting a first plane based on the three-dimensional position of the first point, displaying the real space captured by the imaging apparatus on the display apparatus, specifying a direction to connect with an object as a second line-of-sight direction using the displayed image, specifying a second point based on an intersection of the second line-of-sight direction and the first plane, and calculating a three-dimensional position of the second point.

According to still another aspect of the present invention, an information processing apparatus includes a measurement unit configured to measure a line-of-sight direction of a user, a first specification unit configured to specify a first point based on the first direction measured by the measurement unit, a first calculation unit configured to calculate a three-dimensional position of the first point, a setting unit configured to set a first plane based on the three-dimensional position of the first point, a second specification unit configured to specify a second point included in the first plane based on a second direction measured by the measurement unit after the setting of the first plane, and a second calculation unit configured to calculate a three-dimensional position of the second point.

According to a further aspect of the present invention, an information processing apparatus includes an imaging apparatus, a display apparatus, and a storage unit storing a three-dimensional model in a scene. The information processing apparatus includes a direction specification unit configured to specify a direction from a view point toward an object as a first line-of-sight direction using an image formed by capturing a real space with the imaging apparatus and displayed on the display apparatus, a first point specification unit configured to specify an intersection of the first line-of-sight direction and the three-dimensional model as a first point, a calculation unit configured to calculate a three-dimensional position of the first point based on the three-dimensional model, a setting unit configured to set a first plane based on the three-dimensional position of the first point, a second point specification unit configured to specify a second point as an intersection of a second line-of-sight direction specified by the direction specification unit after the setting of the first plane and the first plane, and a calculation unit configured to calculate a three-dimensional position of the second point.

According to a further aspect of the present invention, an information processing apparatus includes an imaging apparatus, and a display apparatus. The information processing apparatus includes a direction specification unit configured to specify a direction from a view point toward an object as a first line-of-sight direction using an image formed by capturing a real space with the imaging apparatus and displayed on the display apparatus, a measurement unit configured to measure a depth in the first line-of-sight direction, a first point specification unit configured to specify a first point based on the first line-of-sight direction and the depth, a calculation unit configured to calculate a three-dimensional position of the first point based on a position of the imaging apparatus, the first line-of-sight direction, and the depth, a setting unit configured to set a first plane based on the three-dimensional position of the first point, a second point specification unit configured to specify a second point as an intersection of a second line-of-sight direction specified by the direction specification unit after the setting of the first plane and the first plane, and a calculation unit configured to calculate a three-dimensional position of the second point.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A to 1E are views for conceptually illustrating a flow for specifying a three-dimensional position according to an exemplary embodiment of the present invention.

FIG. 2 is a view illustrating a situation in specifying a position according to an exemplary embodiment of the present invention.

FIGS. 3A to 3F are views illustrating a selection process.

FIG. 4 is a view illustrating a configuration of an information processing apparatus.

FIG. 5 is a flowchart illustrating an overall processing procedure in a three-dimensional position acquiring method.

FIG. 6 is a flowchart illustrating a detailed procedure in processing for combining a virtual image including a line-of-sight image and a captured image and displaying the combined image.

FIG. 7 is a flowchart illustrating a detailed procedure for calculating a position of a first point.

FIG. 8 is a flowchart illustrating a detailed procedure for combining a virtual image including a first plane and a captured image and displaying the combined image.

FIG. 9 is a flowchart illustrating a detailed procedure for displaying a virtual image viewed from a second point.

FIG. 10 is a view illustrating processing for adjusting a viewpoint length according to an exemplary embodiment of the present invention.

FIG. 11 is a view illustrating processing for drawing an auxiliary line from an end point of a view point and displaying the auxiliary line.

### DETAILED DESCRIPTION OF THE EMBODIMENTS

Various exemplary embodiments, features, and aspects of the invention will be described in detail below with reference to the drawings.

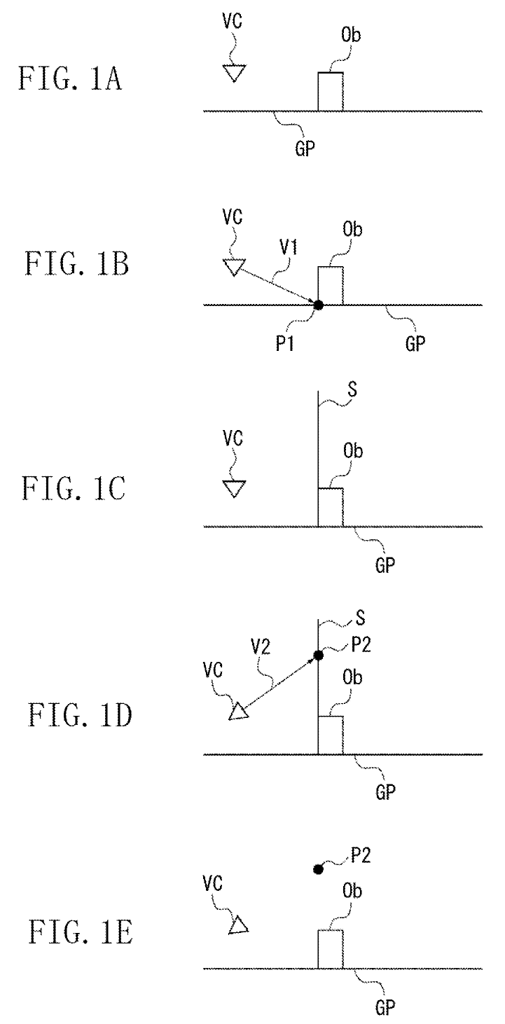

FIGS. 1A to 1E are views for conceptually illustrating a flow for specifying a three-dimensional position according to an exemplary embodiment of the present invention.

In FIGS. 1A to 1E, an object OB is on a ground plane GP and a view point of a user VC is at a point a little away from the object Ob viewed from a side. The object Ob and the ground plane GP may be either virtual objects that are virtually displayed based on geometric numeric data representing shapes or positions and the like, or real objects in a real space. Further, the object Ob and the ground plane GP may exist in an environment where virtual objects and real objects are mixed.

Hereinafter, it is assumed that the three-dimensional environment such as the object Ob observed from the view point VC is virtually provided. More specifically, a case is described where a point (position) above a portion where the object Ob contacts with the ground plane GP is specified as a new view point.

A device is a tool used to specify a position or a direction of the view point VC. As the device to specify the position or the direction of the view point VC, for example, a virtual camera is used that is a reference in drawing a virtual object to be presented to a user. More specifically, the device can be implemented by using a display or a head mounted display that can obtain a position and an orientation using a known method, or the other user interfaces. A virtual object viewed from a virtual camera is displayed on a display, a head mounted display, or the like. The methods for generating the data are already known and accordingly, detailed descriptions of the generating methods are not included herein.

The position of the view point VC can be changed by moving a display, or when a user mounts a head mounted display and moves or changes angles of the head.

First, in an environment where the object Ob exists, a view point of a virtual camera is set as a view point VC (FIG. 1A). In this state, if the virtual camera is moved by a user, the virtual camera measures a direction of a line of sight V1 while a visual axis (view point) of the virtual camera is directed toward the object Ob (FIG. 1B). The direction of the line of sight V1 can be obtained, for example, in a case of a virtual environment, by using various parameters acquired from setting conditions of the virtual camera. In a case where a user interface for specifying a viewpoint position is used, the direction of the line of sight V1 can be obtained by using information from a position and orientation sensor.

In the case where the image is captured by moving the positions of the virtual camera, it is desirable to determine a fixed point in a three-dimensional space as an original point of a three-dimensional position coordinate, and obtain a three-dimensional position of the virtual camera relative to the original point at the same time.

Hereinafter, a three-dimensional position and a line of sight direction of a virtual camera are determined. However, for example, if all virtual objects are displayed relative to a position of the virtual camera by setting the position of the virtual camera as an original point, it is not always necessary to determine the position of the virtual camera. In such a case, the position of the virtual camera is consistently set as the original point.

A three-dimensional position and a line of sight direction of a view point VC of the virtual camera are specified, so that a position and a direction of a first line of sight V1 of the virtual camera are specified in the three-dimensional space. For example, the first line of sight V1 can be described by an equation of a three-dimensionally represented straight line.

Then, the virtual camera specifies a first point P1 based on the direction of the first line of sight V1 (FIG. 1B). For example, the virtual camera extracts a point where the first line of sight V1 and a plane that forms a virtual object or a ground firstly intersect with each other viewed from the virtual camera side, from a group of points that form the virtual object or the ground.

In FIG. 1B, the first point P1 is defined as a point where the first line of sight V1 intersects with a line on which the object OB contacts with the ground plane GP.

The virtual camera calculates a three-dimensional point of the first point P1. In three-dimensional data of the virtual object or the ground plane, a group of positions forming the virtual object or the ground plane, or mathematical expressions defining lines or planes are included. Accordingly, the virtual camera can calculate the three-dimensional position of the first point P1 by extracting a point with which the first line of sight V1 intersects, from the planes that form the virtual object or the ground plane. The user can recognize that the first point is set by a virtual image formed based on the data of the virtual object representing the first point P1 at the calculated position.

The virtual camera sets a first plane S based on the calculated three-dimensional position of the first point P1 (FIG. 1C). The first plane S is set based on the first point P and conditions that are set in advance or conditions that are set by the user in each case.

In the present exemplary embodiment, the conditions are set such that the first plane S includes the first point P1, the plane S is a plane perpendicular to the ground plane and perpendicular to the plane that includes the view point VC and the first point P1.

Based on the conditions, a position of the plane in the three-dimensional space is determined. Thus, conditions to specify a position and an orientation of the first plane S in the three-dimensional space, for example, mathematical expressions defining the plane or a group of positions forming the plane can be calculated.

Then, the user turns the view point VC to a specific point that is selected on the first plane S by moving the virtual camera. Similar to the calculation of the first point P1, the virtual camera calculates a line of sight (referred to as second line of sight V2) of the virtual camera at the time (FIG. 1D). The direction of the second line of sight V2 can be a direction totally different from the first line of sight V1.

The virtual camera specifies a second point P2 on the first plane S based on the direction of the second line of sight V2. For example, the second point P2 can be calculated as an intersection of the direction of the second line of sight V2 and the first plane S. A three-dimensional position of the second point P2 can be calculated based on the first plane S and position and orientation information of the second line of sight V2, and finally, the second point P2 is specified in the three-dimensional space. The user can recognize the three-dimensional position of the second point P2 by presentation of the position using the data of the virtual object similar to the first point P1 (FIG. 1E).

As described above, the user can readily obtain the point that exists at the position different from the current view point by simply changing the directions of the device to the first line of sight direction and the second line of sight direction and selecting the point.

Further, the virtual camera is used as the device, and the display for displaying the three-dimensional space can be provided at the opposite side. An image at a view point of the virtual camera can be displayed on the display so that the view point corresponds to a direction of the user's view point. Thus, the three-dimensional position of the point can be further readily specified. In this case, the first point and the second point can be readily set by changing the directions of the device to directions to be specified while viewing the three-dimensional space with button operation or the like. The technique is useful especially in specifying a three-dimensional position using a small portable apparatus since the operation can be implemented simply by turning the device to a target and pressing the button.

In the exemplary embodiment described above, the three-dimensional environment such as the object or the ground plane to be observed from a view point is virtually provided. On the other hand, under a real environment, a real object can be used.

In this case, three-dimensional environment information viewed from a user view point is obtained using an imaging apparatus. Accordingly, in addition to the case described above, the information processing apparatus can further include an imaging apparatus and perform the processing by displaying an image captured by the imaging apparatus on a display apparatus.

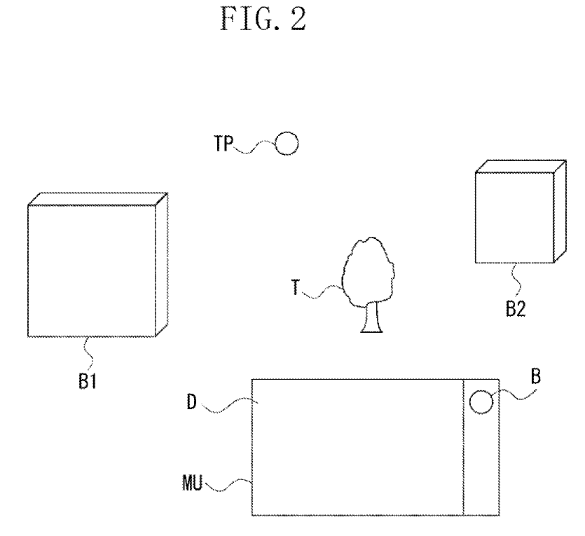

Hereinafter, an image captured by the imaging apparatus is displayed on the display apparatus and a three-dimensional position is specified according to the present exemplary embodiment with reference to FIG. 2.

FIG. 2 is an example of a three-dimensional model of scenery (scene) that a user is viewing. FIG. 2 shows a three-dimensional illustration in which within a visual field in front of the user, two buildings B1 and B2 exist and a tree T exists between the buildings, and a final target point TP is to be specified as a second point.

The user uses a button B and a portable apparatus MU that has a display D to capture a real environment. The portable apparatus MU includes an imaging device (not shown) at the opposite side of the display D. An image captured by the imaging device is displayed on the display D.

It is assumed that the user selects, as a second point TP, a point above the tree T and at an upper part a little closer to the left building B1.

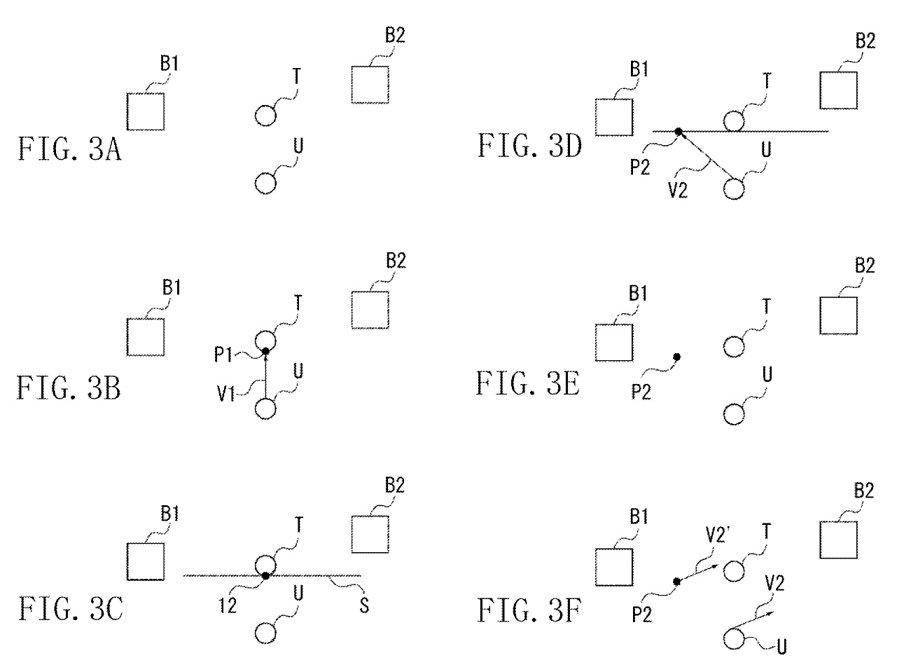

FIGS. 3A to 3F are views illustrating the three-dimensional environment in FIG. 2 viewed from above, and a process to select the second point TP according to the second exemplary embodiment of the present invention.

First, a positional relationship at a start of the processing is illustrated in FIG. 3A. A user U captures the tree T from a view point of the user using the portable apparatus MU. At the time, on the display D of the portable apparatus MU, the two buildings B1 and B2, and the tree T between the buildings are displayed.

As illustrated in FIG. 3B, a line of sight of the user U to the tree T is defined as a first line of sight V1. To set the direction of the first line of sight V1, for example, on the display D of the portable apparatus MU, a marker that corresponds to a line of sight (hereinafter, referred to as line of sight of camera) of the imaging apparatus is displayed in advance and utilized. When the marker corresponds to a point on the tree T, for example, at a root of the tree T on the display D, the user U presses the button B. At the time the button B is pressed, a position and an orientation of the imaging device of the portable apparatus MU are measured and recorded. Based on the position and the orientation of the imaging device, the direction of the first line of sight V1 can be calculated.

An intersection of the first line of sight V1 and the tree T, more specifically, a closest point of the tree T viewed from the user U, is a first point P1.

To acquire the position of the first point P1, for example, virtual data of the tree T that is provided in advance is used. In the virtual data, data of shapes of the objects in the three-dimensional space is recorded together with their positions and orientations. If the virtual data includes coordinates (world coordinates) corresponding to the real environment, similar to the first exemplary embodiment, the position of the first point P1 can be calculated by simply specifying a point of the tree T.

Further, if positional information of the portable apparatus MU in the real environment can be obtained, even if the virtual data does not include the coordinates (world coordinates) corresponding to the real environment, the portable apparatus MU can obtain an absolute position (a position in the world coordinates) of the first point P.

Further, if the positional information of the portable apparatus MU in the real environment is not obtained, and the virtual data does not include the coordinates (world coordinates) corresponding to the real environment, the portable apparatus MU can obtain a relative positional relationship between the portable apparatus MU and the tree T that is virtual data.

Further, if the virtual data includes the coordinates (world coordinates) corresponding to the real environment, the portable apparatus MU can obtain a position and an orientation of the portable apparatus MU by checking the displayed image with the image captured by the portable apparatus MU.

To obtain the positions and the orientations of the first point P1 and the portable apparatus MU by checking the virtual image with the real image, the following method can be provided.

First, the portable apparatus MU captures a real environment (in the example of FIG. 2, the buildings B1 and B2 and the tree T) using the imaging device, and extracts characteristic points such as outlines of the objects by image processing. The portable apparatus MU compares the characteristic points of the objects that exist in the real environment with characteristic points in the provided virtual data. Then, the portable apparatus MU matches the characteristic points in the real and virtual environments with each other. Thus, the portable apparatus MU can obtain the positions and orientations of the real objects and the virtual objects.

Then, as illustrated in FIG. 3C, the portable apparatus MU defines and displays a first plane S that passes through the first point P1 and is perpendicular to the first line of sight V1 and the ground. The definition method is similar to the one described in the above-described exemplary embodiment. The first plane S is superimposed on the real environment and displayed on the display D.

As illustrated in FIG. 3D, the portable apparatus MU specifies a direction of a second line of sight V2 and specifies an intersection with the plane S as a second point P2. FIG. 3E shows that the second point P2 is finally specified.

As described above, the user can specify the second point P2 that is the final target point.

FIG. 3F illustrates a case where the direction of a line of sight V2 is changed after the second point P2 is specified as a new view point. The user can obtain a virtual image viewed from the new view point P2 as a displayed image at the time the second point P2 is specified.

That is, the user can feel as if the user is at the position of the view point P2 and can obtain a desired image by moving the portable apparatus MU in a desired direction. For example, as illustrated in FIG. 3F, when the user desires to obtain an image of the direction V2′ to the tree T from the view point P2, the target image can be obtained by turning the portable apparatus MU so that the line of sight V2 faces toward the same direction.

On the display D of the portable apparatus MU, a real image is displayed. Further, it is possible to display a virtual image together with the real image on the display D. In the mixed reality environment where the real image and the virtual image are mixed, it is possible to superimpose virtual data such as a first line of sight direction, a first point, a first plane, a second line of sight direction, and a second point on the real environment. Further, if the position and orientation information of the portable apparatus MU includes an error, gaps are generated between the virtual image and the real image. Then, it is possible to realize that the error is generated in the position and orientation of the portable apparatus MU.

As described above, according to the present exemplary embodiment of the present invention, the user can specify and input the second point simply by turning the direction of the portable apparatus MU to the first point and the second point to be specified and pressing the button at the points to be specified while watching an image.

Accordingly, it is not necessary to perform the complicated input operation using the mouse or the joystick. The user can further intuitively specify three-dimensional points, so that the specification operation on the portable apparatus becomes easier.

Next, by the method for specifying a three-dimensional point according to the present exemplary embodiment, a specific three-dimensional point is specified and a virtual image is displayed from the view point.

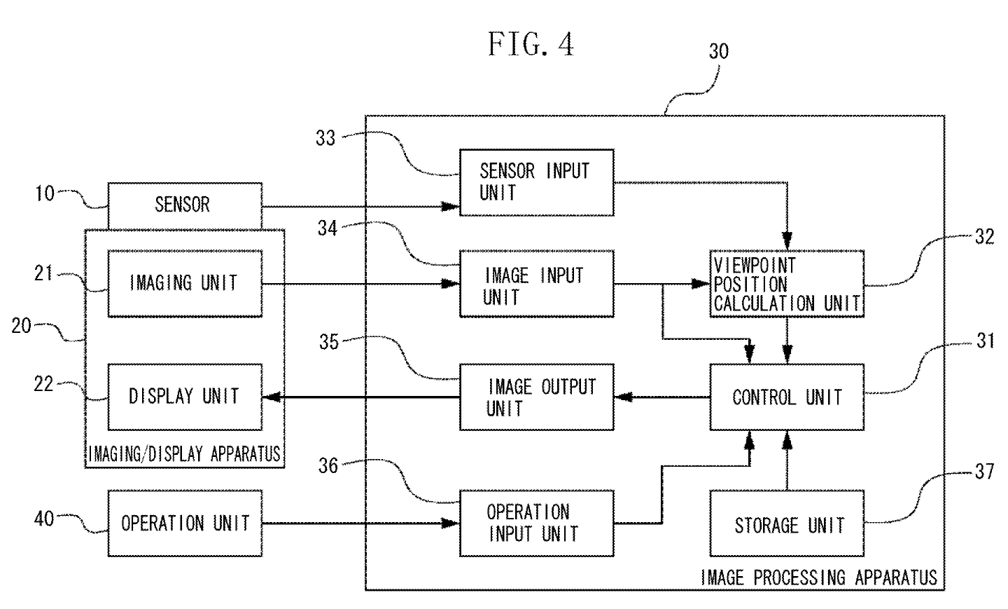

FIG. 4 is a view illustrating an example of a configuration of an information processing apparatus according to the present exemplary embodiment of the present invention.

The information processing apparatus according to the present exemplary embodiment includes a sensor 10, an imaging/display apparatus 20, an image processing apparatus 30, and an operation unit 40. The sensor 10, the imaging/display apparatus 20, the image processing apparatus 30, and the operation unit 40 can be configured as the single portable apparatus MU illustrated in FIG. 2. Further, the sensor 10, the imaging/display apparatus 20, and the operation unit 40 can be configured as a single portable apparatus and the portable apparatus can communicate with the image processing apparatus 30 by radio.

The sensor 10 is installed in the imaging/display apparatus 20, and measures a position and an orientation (hereinafter, referred to as position and orientation at a view point) by setting the position of the imaging/display apparatus 20 as a view point. The sensor 10 can be formed as an ultrasonic type, a magnetic type or an optical type which is already known. Accordingly, their detailed descriptions are not included herein.

The imaging/display apparatus 20 includes an imaging unit 21 and a display unit 22. An image captured by the imaging unit 21 is transmitted to the image processing apparatus 30 and the image transmitted from the image processing apparatus is displayed on the display unit 22. The imaging/display apparatus 20 may be a head mounted display apparatus or a handheld display apparatus.

The image processing apparatus 30 includes a control unit 31, a viewpoint position calculation unit 32, a sensor input unit 33, an image input unit 34, an image output unit 35, an operation input unit 36, and a storage unit 37.

The control unit 31 implements a control program for implementing processing described below stored in the storage unit 37 to control each unit. The viewpoint position calculation unit 32 calculates a position and orientation at a view point based on a measured value of the sensor 10 that is input via the sensor input unit 33 and a captured image that is input via the image input unit 34. The image output unit 35 transmits the image output from the control unit 31 to the imaging/display apparatus 20. The operation input unit 36 outputs an instruction received from a user via the operation unit 40 to the control unit 31.

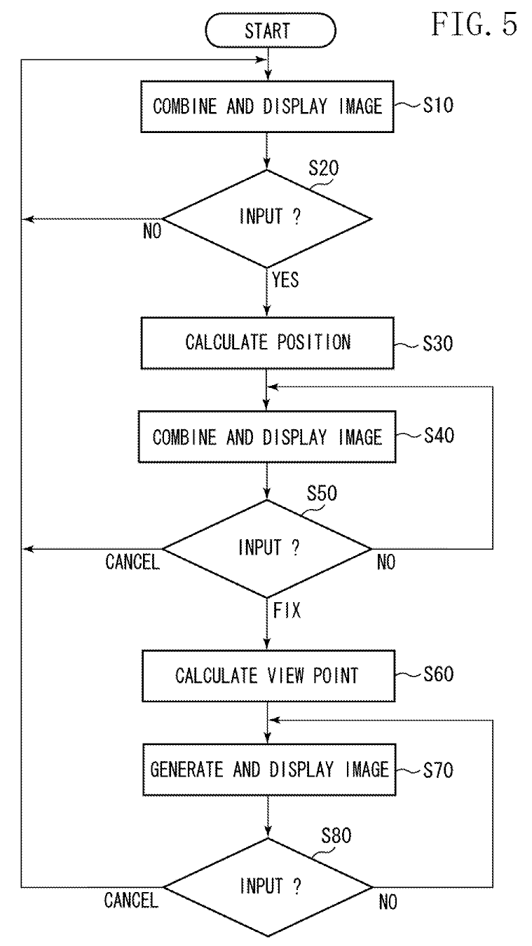

The storage unit 37 stores a three-dimensional (3D) environment model in addition to the above-described control program. The three-dimensional environment model is a three-dimensional model for calibrating a three-dimensional space. The three-dimensional environment model includes a part or all of three-dimensional shape data, three-dimensional positions, and orientation data of objects (a building, a tree, goods, a person, etc.) that exist in a three-dimensional space where the user implements the three-dimensional position specification. The method to specify a three-dimensional position in a real environment using the information processing apparatus illustrated in FIG. 4 is described with reference to a flowchart shown in FIG. 5.

FIG. 5 is a flowchart illustrating an overall processing procedure in the three-dimensional position acquiring method according to the present exemplary embodiment of the present invention.

The processing procedure illustrates a case where the three-dimensional position specification method according to the present exemplary embodiment is used in a mixed reality (MR) environment where a real environment and a virtual environment are mixed. The MR environment is a state where a virtual object, a point, a pointer, or the like are displayed or can be displayed on the same screen together with a real object captured by a camera in consideration of a positional relationship with the real object.

In FIG. 5, first, in step S10, a real environment is captured in a field of view of the MR environment (MR visual field). Then, on the real image captured by the imaging unit 21, a virtual object indicating a beam of a virtual line of sight is combined, and the combined image is displayed on the display unit 22. The virtual line of sight shows a current line-of-sight direction of the imaging unit 21. For example, the virtual line of sight is a virtual laser pointer that connects a view point to a target with a red line. The user presses an operation button of the operation unit 40 when a first point to be specified corresponds to an end point of the virtually displayed laser pointer. In step S20, the control unit 31 determines whether an input operation is performed by the operation button. If the input is not detected (NO in step S20), the processing returns to step S10 and the processing is repeated.

If the input is detected (YES in step S20), the processing proceeds to step S30. In step S30, the control unit 31 calculates a position of the specified point (first point).

In step S40, the control unit 31 forms a first plane, which is a vertical wall, based on the specified first point, and combines and displays the first plane on the real image. After the first plane is displayed, the virtual laser pointer is displayed again. The user, similar to the first point, presses the operation button of the operation unit 40 when a second point to be specified corresponds to an end point of the virtually displayed laser pointer. In step S50, the control unit 31 determines whether an input operation is performed using the operation button. If the input is not detected (NO in step S50), the processing returns to step S40 and the processing is repeated.

If the input is detected (FIX in step S50), the processing proceeds to step S60. In step S60, the control unit 31 calculates a view point position of the second point. The calculation can be performed similar to the first point. In step S50, if a cancel instruction is input via a cancel button (CANCEL in step S50), the processing returns to step S10.

After the three-dimensional position of the second point is calculated (step S60), in step S70, the control unit 31 forms and displays an image in a field of view of the virtual environment (VR visual field) viewed from the second point. In the VR field, all of the displayed things are virtual objects. However, the objects to be displayed are not limited to the graphics generated using computers, but a real image at the second point formed by reconfiguring a plurality of real images can be used. In step S80, the control unit 31 determines whether an input is performed via the cancel button in the operation unit 40. If the input is not detected (NO in step S80), the processing returns to step S70. In step S80, if a cancel instruction is input via the cancel button (CANCEL in step S80), the processing returns to step S10.

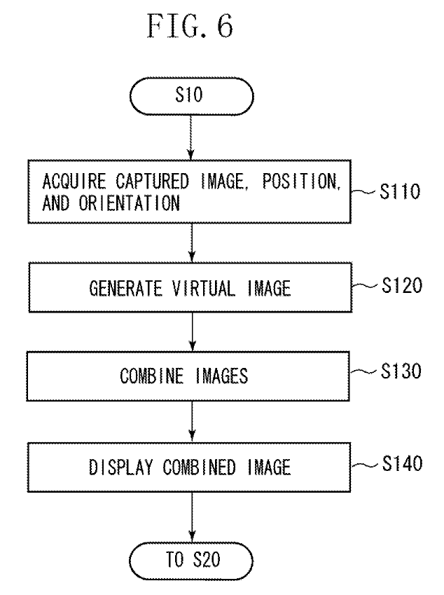

Next, the processing in steps S10, S30, S40, and S70 in FIG. 5 is described in detail with reference to FIGS. 6 to 9, respectively.

FIG. 6 is a flowchart illustrating a detailed procedure in the processing for combining a virtual image including a line-of-sight image and a captured image and displaying the combined image (step S10 of FIG. 5).

In step S110, the control unit 31 acquires the current captured image and the position and orientation of the imaging/display apparatus 20 calculated by the view point position calculation unit 32.

In step S120, the control unit 31 generates a virtual image viewed from the acquired position and orientation based on the data corresponding to the acquired position and orientation stored in the storage unit 37. The virtual image includes the above-described line-of-sight image.

In step S130, the control unit 31 combines the generated image with the acquired captured image.

In step S140, the control unit 31 transmits the combined image from the image output unit 35 to the display unit 22. Then, the combined image is displayed on the display unit 22.

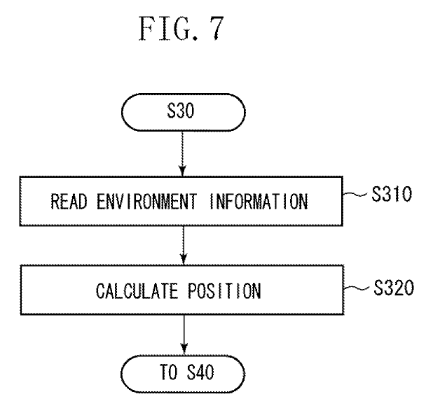

FIG. 7 is a flowchart illustrating a detailed procedure in the calculation of the position of the first point in step S30 of FIG. 5.

In step S310, the control unit 31 reads environment information corresponding to the position and orientation information of the view point from the storage unit 37 at the time the operation button is pressed.

In step S320, the control unit 31 calculates a position of a point where the line-of-sight image intersects with an object (virtual object or real object) as the position of the first point based on the read environment information and the position and orientation of the view point.

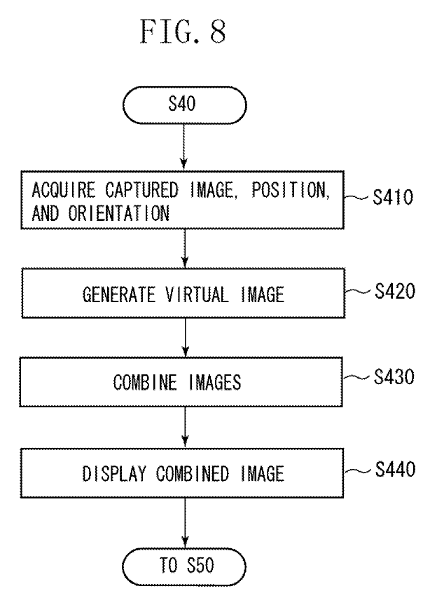

FIG. 8 is a flowchart illustrating a detailed procedure in combining the virtual image including the first plane and the captured image (step S40 of FIG. 5).

In step S410, the control unit 31 acquires the image captured by the imaging unit 21 and the position and orientation of the imaging/display apparatus 20.

In step S420, the control unit 31 generates the virtual wall that indicates the first plane and the virtual image that includes the new line-of-sight image based on the first point and the position and orientation of the imaging/display apparatus 20.

In step S430, the control unit 31 combines the generated virtual image with the captured image.

In step S440, the control unit 31 outputs the combined image via the image output unit 35 to the display unit 22. The display unit 22 displays the combined image.

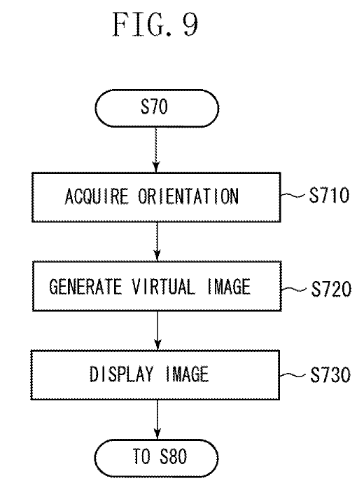

FIG. 9 is a flowchart illustrating a detailed procedure in displaying the virtual image viewed from the second point in step S70 in FIG. 5.

In step S710, the control unit 31 acquires the position and orientation calculated by the viewpoint position calculation unit 32. It is noted that in the following processing, only the orientation is used.

In step S720, the control unit 31 generates the virtual image in the acquired orientation direction viewed from the second view point based on the acquired orientation and the second point calculated in step S60.

In step S730, the control unit 31 transmits the generated virtual image via the image output unit 35 to the display unit 22. The display unit 22 displays the received virtual image.

In the present exemplary embodiment, the image captured by the imaging device is displayed on the display such that the line-of-sight direction in which the user sees the real object becomes the same as the direction of the view point in which the user sees the display. Accordingly, if this exemplary embodiment is applied to a portable apparatus, while seeing the three-dimensional space, the user turns the imaging unit to a direction to specify the first point and specifies the position of the first point using the button. Then, the first plane is displayed. Subsequently, the user turns the imaging unit to a direction to specify the second point and specifies the position of the second point using the button. The operation necessary to specify the second point that is the final target point is only the turning operation of the imaging unit to see the points to be specified and the button operation.

Accordingly, for example, while making a journey, the user can readily acquire and see an image from a virtual view point using the portable apparatus that is installed with the three-dimensional position specification method according to the present exemplary embodiment.

For example, in recent years, aerial detailed images around the world are available to the public online. Further, some web pages for uploading images uniquely captured by individual users in each place are publicized. While making a journey, the user can readily see a combined image viewed from a specified virtual view point by forming an image viewed from a second point using such an online image according to the image combination processing based on information about a position and orientation of the second point.

An information processing apparatus can include an imaging apparatus and a display apparatus. A real space captured by the imaging apparatus can be displayed on the display apparatus in order to specify a direction that connects to an object as a line-of-sight direction using the displayed image.

Further, in the case where the information processing apparatus includes the imaging apparatus and the display apparatus and a real space captured by the imaging apparatus is displayed on the display apparatus, a point on an object in the displayed image can be specified in order to specify a direction that connects to the point on the object from a view point as a line-of-sight direction.

More specifically, a marker corresponding to a line-of-sight of a camera is displayed on the display D of the portable apparatus MU in advance, and the marker is utilized. In this method, in a case where a first point and a second point are selected on the screen, in order to completely correspond to the line-of-sight of the camera, for example, an optical axis of the camera is set to correspond to a center of the screen, and the marker is set at the center of the screen.

However, it is not always necessary to match the optical axis of the optical system of the camera with the center of the display. For example, a specific point in the captured image displayed on the display can be specified by vertically or horizontally moving a cursor on the screen.

In this case, due to the operation to move the cursor on the screen, the overall operation becomes complicated. Accordingly, especially in a case where the method for specifying the three-dimensional position according to the third exemplary embodiment is applied to the portable apparatus, it is desirable that the portable apparatus is moved using a fixed marker on the screen without moving the cursor to select first point or second point as the target.

In the above-described exemplary embodiments, video see-through display apparatuses are used. However, optical see-through display apparatuses that optically transmit light can also be used.

More specifically, for example, a transparent touch panel or an optical see-through head mounted display can be used as a device. In a case where the transparent touch panel is used, an object to be captured can be seen through the panel, and a point on a line-of-sight can be specified on the screen. Accordingly, it is not necessary to provide an imaging device such as a charge-coupled device (CCD) or a complementary metal-oxide semiconductor (CMOS) and a liquid crystal display to display the object and point. Further, a device can be provided with a red point in a transparent plate and a point to be specified can be set on the red point. Further, a hollow cylinder can be used as a device to look into a point to be specified.

Further, if the optical see-through head mounted display is used as a device, an object that is seen through the display and a virtual object can be displayed at a same time. Accordingly, a part or all of a first line-of-sight direction, a second line-of-sight direction, a first point, a second point, and a first plane can be specified or displayed.

Further, if a step to detect the above-described positions and orientations of the devices is provided, it is possible to calculate positions and orientations of the specified line-of-sight directions and points.

In addition to the above-described exemplary embodiments, a mechanism to measure a depth of a line-of-sight can be further provided to utilize a direction and a depth of the line-of-sight.

More specifically, in the second exemplary embodiment, in order to specify the first point, the position of the intersection with the line-of-sight of the camera is calculated using the three-dimensional environment model. However, if a distance between a camera and a point to be specified is measured, based on a position and orientation (direction of a line-of-sight of the camera) of the camera and the distance from the camera, a three-dimensional position of the first point can be calculated. In this case, the first point can be calculated without using the three-dimensional environment model.

As the method for measuring the depth, a time-of-flight method can be used. In the method, an object is irradiated with an ultrasonic wave, infrared light, or the other electromagnetic waves. Reflected light, radio wave, or sound wave is observed, and time taken for the reflection is measured and the distance is calculated.

In an area where a real object exists in front of a first plane, forms for displaying the first plane can be changed. More specifically, in the above-described exemplary embodiment, in a case where a real object exists in front of the first plane, if the virtually displayed first plane covers over the real object in sight, it may be difficult to recognize the positional relationship between the first plane and the real environment.

In such a case, the first plane can be formed to be transparent so that a part of an object behind the first plane can be seen through.

Further, in the case where the object exists in front of the first plane, it is possible to refrain from displaying the first plane. In the case where the object exists behind the first plane, the first plane can be displayed.

Further, in the case where the object exists in front of the first plane, virtual data of the object can be superimposed such that it looks like as if the object exists in front of the first plane.

According to the above-described operation, the positional relationship between the real object and the first plane can be recognized more easily after the first plane is set and displayed, and the subsequent specification of a second point can be readily performed.

In the above-described exemplary embodiments, the first plane is a flat surface. The plane can be perpendicular to a horizontal plane. Further, a direction of the plane can be determined based on a direction of a first line-of-sight. Further, the first plane can be a cylindrical surface centering an imaging device, and the axis can be perpendicular to the horizontal plane. Alternatively, the first plane can be spherically formed.

More specifically, in the first exemplary embodiment, the first plane is set flat as the vertical wall, that includes the first point. In addition, the first plane is perpendicular to the ground and the plane that includes the vertical camera view point and the first point. However, the first plane is not limited to the above embodiment and can also be set under the following conditions.

In the exemplary embodiments, the first plane is the vertical wall. However, the first plane can be a cylindrical surface, a spherical surface, a partial cylindrical surface, or a partial spherical surface. For example, in a case where a view point is specified within a certain radius on the ground, the cylindrical surface can be used.

Further, in the exemplary embodiments, the direction of the first plane is set as the vertical wall in the direction perpendicular to the user. However, the first plane is not limited to the above direction, for example, the direction of the first plane can be set at 30° or 60°. Further, the direction of the first plane can also be set by the user depending on situations. For example, in a case where a road or a railroad exists, and an image viewed from above the road or the railroad is to be obtained, the vertical wall can be rotated so as to correspond to the road or the railroad.

Further, the direction of the first plane is set as the vertical wall perpendicular to the ground plane. However, the first plane is not limited to the above direction. The first plane can be tilted at 10° or 30° from a direction perpendicular to the ground plane.

The above-described shapes and directions of the first plane as the vertical wall can be changed by the user depending on situations.

In specifying a first point, a length of a first line-of-sight can be changed. Further, in specifying the first point, a shadow of a second point can be drawn on a horizon plane. Further, in specifying the first point, a height of the second point can be displayed next to the point.

Instead of setting a first plane, based on a three-dimensional position of a first point, a bar that is perpendicular to a model plane can be set. A point on the bar can also be used to specify a second point.

More specifically, in the above-described exemplary embodiment, to specify the first point P1, the position of the intersection with the line-of-sight of the camera is calculated using the three-dimensional environment model. However, it is not always necessary to calculate the intersection with a target object. A distance from the camera can be set by virtually displaying a beam in a direction of the line-of-sight of the camera, and setting a length of the beam.

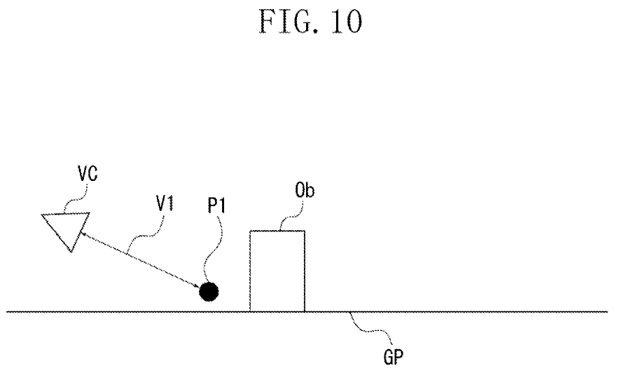

For example, as illustrated in FIG. 10, in specifying a first point P1, a length of a first line-of-sight V1 can be adjusted according to an operation of the user. Based on a position of a view point VC and a direction and the length of the first line-of-sight V1, the first point P1 can be specified as an end of the first line-of-sight V1. However, a positional relationship with peripheral objects is not clear by just changing the length of the beam of the first line-of-sight V1. Accordingly, as described above, it is desirable to select the first point that is an intersection of an object and a beam. Thus, the specification method using the length of a beam is effective in a case where an appropriate object does not exist around a point to be specified, accuracy in distance measurement using a range finder is not enough, or accuracy of virtual data is low.

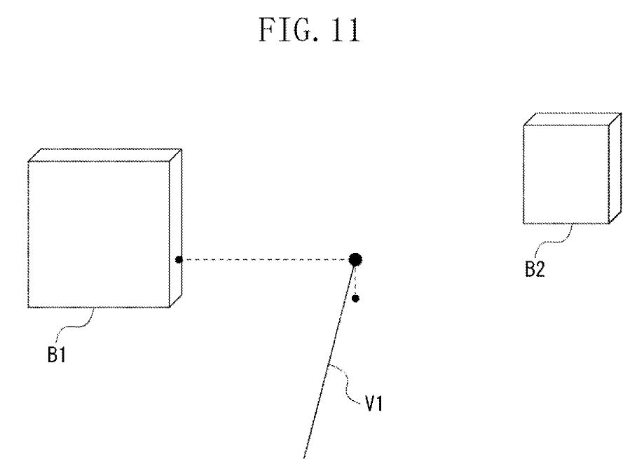

Further, as illustrated in FIG. 11, in specifying a first point, a length of a first line-of-sight V1 can be changed. An auxiliary line can be extended from an end point of the first line-of-sight V1 in a vertical direction or a horizontal direction to grasp a positional relationship with ground or an adjacent object. Accordingly, a height and direction of the first point can be recognized more clearly.

In the example in FIG. 11, the tree T is removed from the arrangement illustrated in FIG. 2 and the first line-of-sight V1 is extended between the building B1 and the building B2. A point where the first line-of-sight V1 extended from the end point in the vertically-down direction intersects with the ground plane and a point where the first line-of-sight V1 extended in the horizontally-left direction intersects with the adjacent building B1 are displayed in FIG. 11. Accordingly, the user can clearly recognize the position of the end point of the first line-of-sight V1 in the three-dimensional space.

In such a display, the direction and length of the first line-of-sight V1 can be adjusted and a second point P2 can be specified by pressing a button at a target point.

Further, in specifying the first point, planes can also be successively displayed. Further, in specifying the first point, an overhead view can also be displayed.

In an exemplary embodiment described above, the first plane is set. The first plane is applicable in various ways other than the selection of a new view point. For example, when a virtual environment and a real environment are mixed, based on the virtually displayed first plane, real objects, for example, some boxes can be arranged.

It is desirable that a three-dimensional model includes a horizontal plane because the horizontal plane can be used as a reference to set a first plane. The horizontal plane can be set and displayed in a virtual environment, as a ground plane that is a base to dispose a virtual object. In a scene of a room, the horizontal plane can be set and displayed as a floor surface. Similarly, in a real environment, a ground plane or a floor surface existing in the real environment can be used as the horizontal plane.

According to the present exemplary embodiments, in the three-dimensional space of a real space, a virtual space, or a space where the real space and the virtual space are mixed, a new point and surface can be readily set.

Each function according to the above-described exemplary embodiments can be implemented by processing of a central processing unit (CPU) according to instructions in program code read from a storage medium.

As the storage medium for storing such program code, for example, a floppy disk, a hard disk, an optical disk, and a magneto-optical disk can be employed. Further, a compact disk (CD), a digital versatile disc (DVD), a magnetic tape, a nonvolatile memory card, and a read-only memory (ROM) can be employed.

In an image input apparatus, an information storage apparatus, a multiple apparatus of the image input apparatus and the information storage apparatus, or an apparatus to which the image input apparatus and the information storage apparatus are connected, CPUs provided at both sides of the apparatuses or a CPU provided in one of the apparatuses can implement a part or all of the actual processing, and thus, the function of one or more of the above described embodiments is realized.

As the image input apparatus, various cameras using a CCD such as a video camera, a digital camera, a monitoring camera, a scanner, or an image input apparatus that inputs an image converted by an analog image input apparatus by analog-digital conversion into a digital image can be used. As the information storage apparatus, an external hard disk, a video recorder, or the like can be used.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-139373 filed May 25, 2007 which is hereby incorporated by reference herein in its entirety.

What is claimed is:

1. An information processing method comprising:
measuring a line-of-sight direction of a user as a first direction;
specifying a first point based on the first direction;
calculating a three-dimensional position of the first point;
setting a first plane based on the three-dimensional position of the first point;
measuring a line-of-sight direction of the user after the setting of the first plane as a second direction;
specifying a second point included in the first plane based on the second direction; and
calculating a three-dimensional position of the second point.

2. The information processing method according to claim 1, wherein in the specifying of the first point, an intersection of the first direction and a predetermined object is specified as the first point.

3. The information processing method according to claim 1, wherein in the setting of the first plane, a plane that includes the first point and is perpendicular to a predetermined surface is specified as the first plane.

4. The information processing method according to claim 1, wherein the line-of-sight direction of the user is specified by a device that is operated by the user.

5. The information processing method according to claim 4, wherein the calculating of the three-dimensional position of the first point comprises:
reading a three-dimensional model in an environment where the device is operated, from a storage unit; and
calculating the three-dimensional position of the first point based on the three-dimensional model and the first direction.

6. The information processing method according to claim 1, further comprising displaying an image viewed from the second point.

7. The information processing method according to claim 1, further comprising:
acquiring a real image captured by an imaging unit;
generating a virtual image representing the first plane;
combining the captured real image and the virtual image; and
displaying the combined image.

8. The information processing method according to claim 7, further comprising changing a form of displaying the combined image in an area where a real object exists between the first plane and the imaging unit.

9. The information processing method according to claim 1, further comprising:
measuring a depth in information of the line-of-sight indicating the line-of-sight direction; and
wherein the calculating of the three-dimensional position of the first point is performed based on the line-of-sight direction and the depth.

10. The information processing method according to claim 1, further comprising displaying auxiliary information indicating a height of the first point in specifying the first point.

11. The information processing method according to claim 1, further comprising displaying an overhead view in specifying the first point.

12. The information processing method according to claim 1, further comprising specifying a length in line-of-sight information indicating the line-of-sight direction.

13. A computer-readable storage medium that stores a program for instructing a computer to implement the information processing method according to claim 1.

14. An information processing method comprising:
displaying a real space captured by an imaging apparatus on a display apparatus;
specifying a direction from a view point toward an object as a first line-of-sight direction using the displayed image;
specifying an intersection of the first line-of-sight direction and a three-dimensional model in a scene stored in a storage unit as a first point;
calculating a three-dimensional position of the first point based on the three-dimensional model;
setting a first plane based on the three-dimensional position of the first point;
displaying the real space captured by the imaging apparatus on the display apparatus;
specifying a direction from a view point toward the object as a second line-of-sight direction using the displayed image;
specifying an intersection of the second line-of-sight direction and the first plane as a second point; and
calculating a three-dimensional position of the second point.

15. A computer-readable storage medium that stores a program for instructing a computer to implement the information processing method according to claim 14.

16. An information processing method comprising:
displaying a real space captured by an imaging apparatus on a display apparatus;
specifying a direction from a view point toward an object as a first line-of-sight direction using the displayed image;
measuring a depth in the first line-of-sight direction;
specifying a first point using the first line-of-sight direction and the depth;
calculating a three-dimensional position of the first point based on a position of the imaging apparatus, the first line-of-sight direction, and the depth;
setting a first plane based on the three-dimensional position of the first point;
displaying the real space captured by the imaging apparatus on the display apparatus;
specifying a direction to connect with an object as a second line-of-sight direction using the displayed image;
specifying a second point based on an intersection of the second line-of-sight direction and the first plane; and
calculating a three-dimensional position of the second point.

17. A computer-readable storage medium that stores a program for instructing a computer to implement the information processing method according to claim 16.

18. An information processing apparatus comprising:
a measurement unit configured to measure a line-of-sight direction of a user;
a first specification unit configured to specify a first point based on the first direction measured by the measurement unit;
a first calculation unit configured to calculate a three-dimensional position of the first point;
a setting unit configured to set a first plane based on the three-dimensional position of the first point;
a second specification unit configured to specify a second point included in the first plane based on a second direction measured by the measurement unit after the setting of the first plane; and
a second calculation unit configured to calculate a three-dimensional position of the second point.

19. An information processing apparatus having an imaging apparatus, a display apparatus, and a storage unit storing a three-dimensional model in a scene, the information processing apparatus comprising:
a direction specification unit configured to specify a direction from a view point toward an object as a first line-of-sight direction using an image formed by capturing a real space with the imaging apparatus and displayed on the display apparatus;
a first point specification unit configured to specify an intersection of the first line-of-sight direction and the three-dimensional model as a first point;
a calculation unit configured to calculate a three-dimensional position of the first point based on the three-dimensional model;
a setting unit configured to set a first plane based on the three-dimensional position of the first point;
a second point specification unit configured to specify a second point as an intersection of the first plane and a second line-of-sight direction specified by the direction specification unit after the setting of the first plane; and
a calculation unit configured to calculate a three-dimensional position of the second point.

20. An information processing apparatus having an imaging apparatus, and a display apparatus, the information processing apparatus comprising:
a direction specification unit configured to specify a direction from a view point toward an object as a first line-of-sight direction using an image formed by capturing a real space with the imaging apparatus and displayed on the display apparatus;
a measurement unit configured to measure a depth in the first line-of-sight direction;
a first point specification unit configured to specify a first point based on the first line-of-sight direction and the depth;
a calculation unit configured to calculate a three-dimensional position of the first point based on a position of the imaging apparatus, the first line-of-sight direction, and the depth;
a setting unit configured to set a first plane based on the three-dimensional position of the first point;
a second point specification unit configured to specify a second point as an intersection of the first plane and a second line-of-sight direction specified by the direction specification unit after the setting of the first plane; and
a calculation unit configured to calculate a three-dimensional position of the second point.
